(19) United States
(12) Patent Application Publication
(10) Pub. No.: US 2019/0143894 A1
(43) Pub. Date: May 16, 2019

(54) VEHICLE NOTIFICATION SYSTEM AND COMPUTER PROGRAM PRODUCT

(71) Applicant: DENSO CORPORATION, Kariya-city (JP)

(72) Inventors: Masakazu IKEDA, Nisshin-city (JP); Kaneyoshi UEDA, Kariya-city (JP); Hiroyuki OKUNO, Kariya-city (JP); Tatsuya HAYASHI, Kariya-city (JP)

(21) Appl. No.: 16/250,248

(22) Filed: Jan. 17, 2019

Related U.S. Application Data
(63) Continuation of application No. PCT/JP2017/025562, filed on Jul. 13, 2017.

(30) Foreign Application Priority Data
Jul. 22, 2016 (JP) 2016-144387

(51) Int. Cl. B60Q 9/00; G08G 1/16; H04W 4/40; H04W 4/02

(52) U.S. Cl. CPC B60Q 9/008; H04W 4/027; H04W 4/40; G08G 1/166

(57) ABSTRACT

A vehicle notification system may include a mobile communication terminal and a vehicle communication terminal. The mobile communication terminal and the vehicle communication terminal may perform a wireless communication with one another. The vehicle notification system may detect a terminal position. The vehicle notification system may detect speed of the mobile communication terminal. The vehicle notification system may detect vertical acceleration of the mobile communication terminal. The vehicle notification system may determine whether an action state of the person possessing the mobile communication terminal is walking, running, riding a bicycle, or riding on a vehicle using the speed and the vertical acceleration. The vehicle notification system may predict a risk degree of accident using the terminal position, a determination result of the action state, and the vehicle position. The vehicle notification system may perform a notification by changing a notification content corresponding to the risk degree of accident.

### CROSS REFERENCE TO RELATED APPLICATIONS

The present application is a continuation application of International Patent Application No. PCT/JP2017/025562 filed on Jul. 13, 2017, which designated the United States and claims the benefit of priority from Japanese Patent Application No. 2016-144387 filed on Jul. 22, 2016. The entire disclosures of all of the above applications are incorporated herein by reference.

### TECHNICAL FIELD

The present disclosure relates to a vehicle notification system and a computer program product.

### BACKGROUND

As a system for avoiding a vehicle accident in advance, a vehicle notification system determines an action state of a person possessing a mobile communication terminal, predicts a risk degree of the accident, and notifies a driver.

### SUMMARY

A vehicle notification system may include a mobile communication terminal and a vehicle communication terminal. The mobile communication terminal and the vehicle communication terminal may perform a wireless communication with one another. The vehicle notification system may detect speed of the mobile communication terminal. The vehicle notification system may detect vertical acceleration of the mobile communication terminal. The vehicle notification system may determine whether an action state of the person possessing the mobile communication terminal is walking, running, riding a bicycle, or riding on a vehicle using the speed and the vertical acceleration.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram showing an entire configuration of a first embodiment;

FIG. 2 is a first flowchart showing an action state determination processing;

FIG. 3 is a second flowchart showing the action state determination processing;

FIG. 4 is a flowchart showing a reliability evaluation processing;

FIG. 5 is a flowchart showing a risk level notification processing;

FIG. 6 is a first diagram showing a relationship between time and frequency or between time and amplitude;

FIG. 7 is a second diagram showing the relationship between time and frequency or between time and amplitude;

FIG. 8 is a diagram showing a relationship between speed and vertical acceleration;

FIG. 9 is a diagram showing a transition of a reliability index value;

FIG. 10 is a diagram showing a transition of action states;

FIG. 11 is a diagram showing a determination ratio of each action state;

FIG. 12 is a first diagram showing a relationship between a mobile communication terminal and a vehicle communication terminal;

FIG. 13 is a second diagram showing the relationship between the mobile communication terminal and the vehicle communication terminal;

FIG. 14 is a third diagram showing the relationship between the mobile communication terminal and the vehicle communication terminal;

FIG. 15 is a fourth diagram showing the relationship between the mobile communication terminal and the vehicle communication terminal;

FIG. 16 is a fifth diagram showing the relationship between the mobile communication terminal and the vehicle communication terminal;

FIG. 17 is a sixth diagram showing the relationship between the mobile communication terminal and the vehicle communication terminal;

FIG. 18 is a seventh diagram showing the relationship between the mobile communication terminal and the vehicle communication terminal; and

FIG. 19 is a functional block diagram showing an entire configuration of a second embodiment.

### DETAILED DESCRIPTION

For example, a vehicle notification system determines whether a person possessing a mobile communication terminal is walking or riding on a vehicle. When determining that the person possessing the mobile communication terminal is walking, the vehicle notification system notifies the driver of the position of the mobile communication terminal. When determining that the person possessing the mobile communication terminal is riding on the vehicle, the vehicle notification system does not notify the driver of the position of the mobile communication terminal.

In the vehicle notification system, an accident involving a pedestrian and a vehicle can be avoided in advance by setting the pedestrian as a notification target. The inventor has studied that the vehicle notification system determines that the person is riding on the vehicle even when the person is riding a bicycle. Thus, the person riding the bicycle is out of the notification target. As a result, an accident involving the vehicle and the person riding the bicycle may not be avoided in advance.

An example embodiment of the present disclosure provides a vehicle notification system and a computer program product, each of which is capable of avoiding an accident involving a person possessing a mobile communication terminal and a vehicle in advance by appropriately determining an action state of the person possessing the mobile communication terminal.

In an example embodiment of the present disclosure, a vehicle notification system determines the action state of the person possessing the mobile communication terminal by being classified into walking, running, riding the bicycle or riding on the vehicle. With this configuration, the vehicle notification system according to the present disclosure can appropriately determine the action state of the person possessing the mobile communication terminal, and avoid the accident involving the person possessing the mobile communication terminal and the vehicle in advance.

### First Embodiment

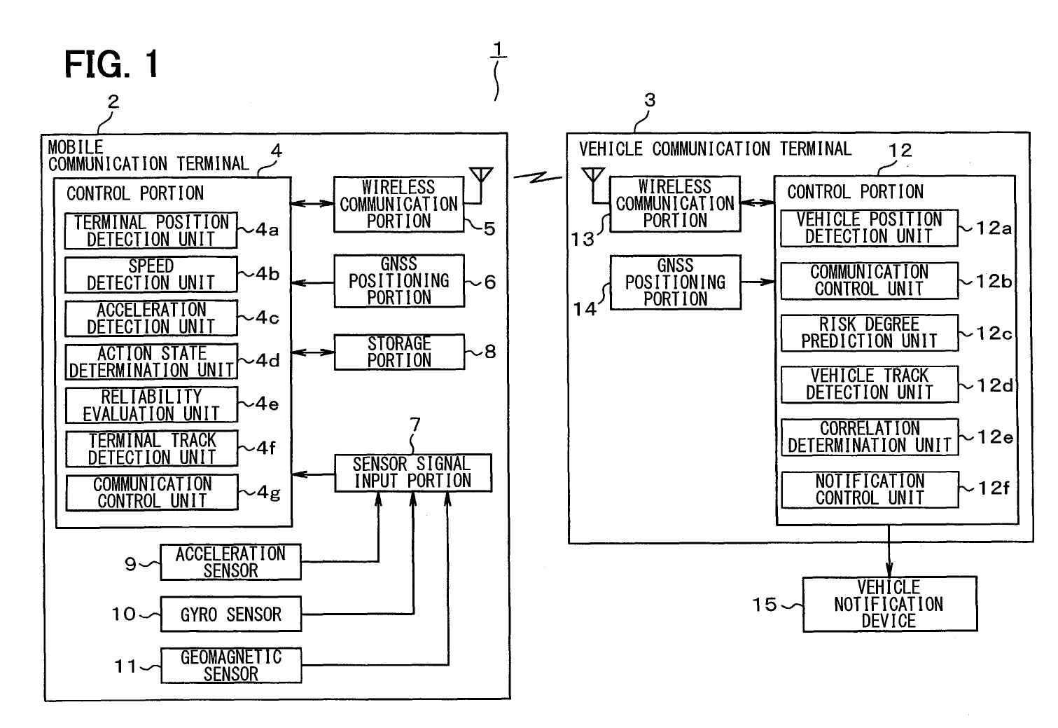

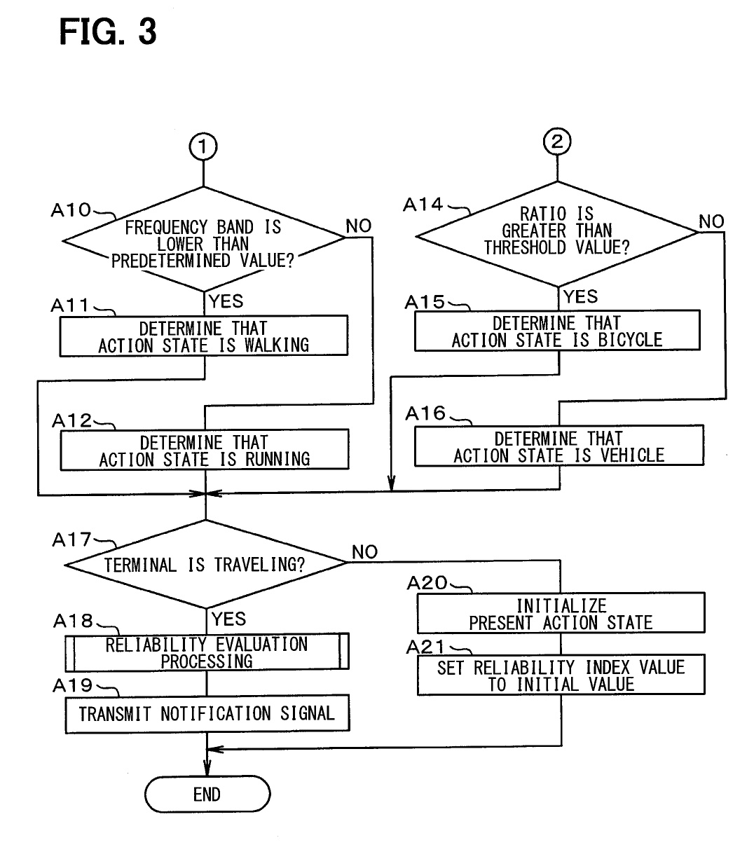

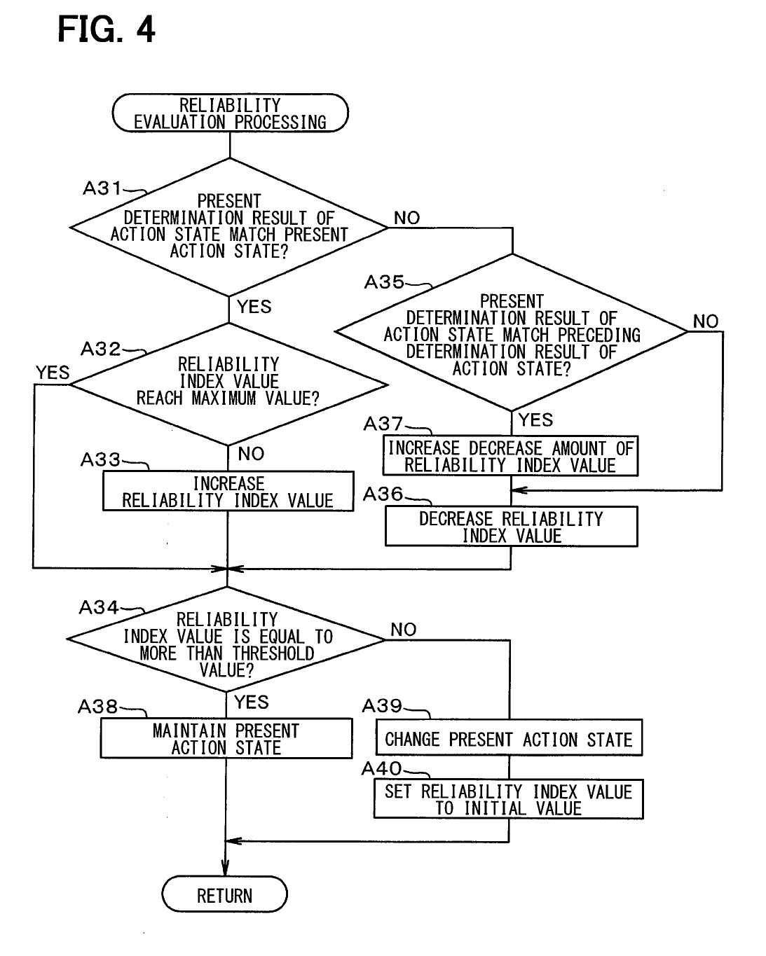

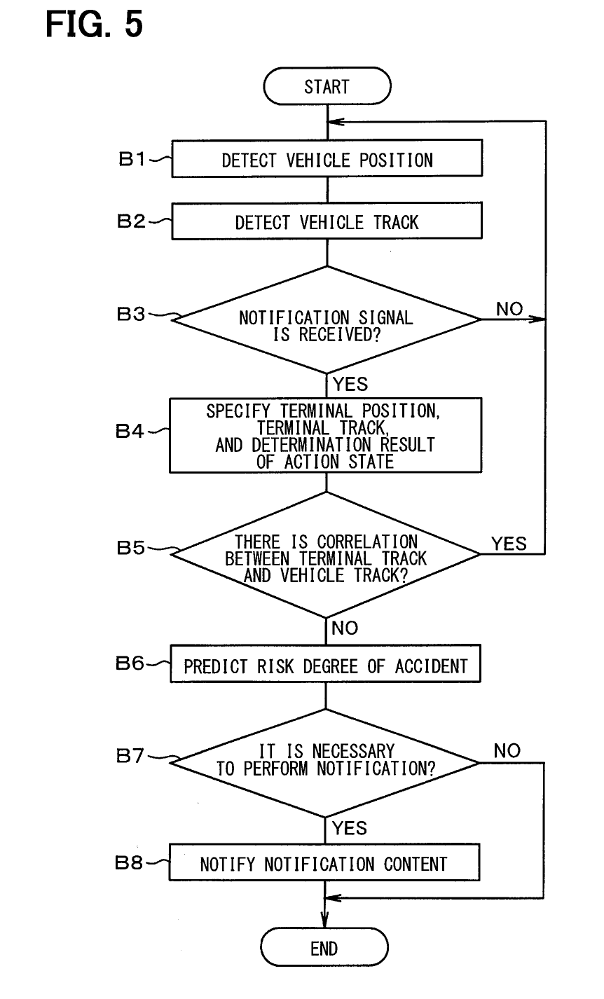

A first embodiment will be described with reference to FIG. 1 to FIG. 18.

As shown in FIG. 1, in a vehicle notification system 1, a mobile communication terminal 2 and a vehicle communication terminal 3 are capable of directly communicating with one another. The mobile communication terminal 2 is possessed by a person, and the vehicle communication terminal 3 is attached to a subject vehicle. The relationship between mobile communication terminals 2 and the vehicle communication terminals 3 is an unspecified and many-to-many relationship. Unspecified multiple number of mobile communication terminals 2 and unspecified multiple number of vehicle communication terminals 3 are capable of communicating with one another. The mobile communication terminal 2 may be provided by a multifunctional mobile phone terminal referred to as a smartphone, which serves functions such as a telephone function, a schedule management function, and the like. The vehicle communication terminal 3 may be provided by a terminal that serves functions such as a navigation function, an audio function, and the like. Alternatively, the vehicle communication terminal 3 may be provided by a navigation terminal. Alternatively, the vehicle communication terminal 3 may be provided by an audio terminal.

The mobile communication terminal 2 includes a control portion 4, a wireless communication portion 5, a GNSS (Global Navigation Satellite System) positioning portion 6, a sensor signal input portion 7, and a storage portion 8. The control portion 4 is provided by a microcomputer having a CPU (Central Processing Unit), a ROM (Read Only Memory), a RAM (Random Access Memory), and an I/O device (Input/Output device). The control portion 4 executes a computer program stored in a non-transitory tangible storage medium to execute a processing corresponding to the computer program, and controls the entire operation of the mobile communication terminal 2.

The wireless communication portion 5 controls wireless communication with the vehicle communication terminal 3. The GNSS positioning portion 6 extracts various types of parameters from the GNSS signal received from the satellites, calculates the present position using the extracted parameters, and transmits the calculation result to the control portion 4. The sensor signal input portion 7 receives sensor signals from an acceleration sensor 9, a gyro sensor 10, and a geomagnetic sensor 11 attached to the mobile communication terminal 2. The sensor signal input unit 7 receives an acceleration signal from the acceleration sensor 9, a gyro signal from the gyro sensor 10, and a geomagnetic signal from the geomagnetic sensor 11. The acceleration signal indicates acceleration acting on the mobile communication terminal 2. The gyro signal indicates gyro acting on the mobile communication terminal 2. The geomagnetic signal indicates terrestrial magnetism acting on the mobile communication terminal 2.

The storage portion 8 has storage areas for storing sensor values indicated by various sensor signals received from the sensors 9 to 11 to the sensor signal input portion 7. That is, the storage portion 8 has the storage area for storing each of the acceleration indicated by the acceleration signal, the gyro indicated by the gyro signal, and the terrestrial magnetism indicated by the geomagnetic signal.

The control position 4 includes a terminal position detection unit 4a, a speed detection unit 4b, an acceleration detection unit 4c, an action state determination unit 4d, a reliability evaluation unit 4e, a terminal track detection unit 4f, and a communication control unit 4g. Each of these units 4a to 4g is provided by a computer program executed by the control portion 4, and is achieved by software.

The terminal position detection unit 4a detects a terminal position indicative of the position of the mobile communication terminal 2 using the calculation result received from the GNSS positioning portion 6. The speed detection unit 4b detects speed of the mobile communication terminal 2 using the change over time of the calculation result received from the GNSS positioning portion 6. The acceleration detection unit 4c calculates a gradient angle of the mobile communication terminal 2 using gyro indicated by the gyro signal received from the gyro sensor 10 and terrestrial magnetism indicated by the geomagnetic signal received from the geomagnetic sensor 11. The acceleration detection unit 4c detects vertical acceleration of the mobile communication terminal 2 by correcting acceleration indicated by the acceleration signal received from the acceleration sensor 9 using the calculated gradient angle.

The action state determination unit 4d, which will be described later, determines whether the action state of the person possessing the mobile communication terminal 2 is walking, running, riding a bicycle, or riding on a vehicle using speed detected by the speed detection unit 4b and vertical acceleration detected by the acceleration detection unit 4c. The reliability evaluation unit 4e calculates a reliability index value indicative of the reliability of the determination result of the action state. The terminal track detection unit 4f detects a terminal track indicative of a track of the mobile communication terminal 2 using the change over time of the calculation result received from the GNSS positioning portion 6. The communication control unit 4g causes the wireless communication portion 5 to transmit a notification signal to the vehicle communication terminal 3. The notification signal includes the terminal position detected by the terminal position detection unit 4a, the determination result of the action state determined by the action state determination unit 4d, and the terminal track detected by the terminal track detection unit 4f.

The vehicle communication terminal 3 includes a control portion 12, a wireless communication portion 13, and a GNSS positioning portion 14. The control portion 12 is provided by a microcomputer having a CPU, a ROM, a RAM, and an I/O device. The control portion 12 executes a computer program stored in a non-transitory tangible storage medium to execute a processing corresponding to the computer program, and controls the entire operation of the vehicle communication terminal 3.

The wireless communication portion 13 controls wireless communication with the mobile communication terminal 2. The GNSS positioning portion 14 extracts various types of parameters from the GNSS signal received from the satellites, calculates the present position using the extracted parameters, and transmits the calculation result to the control portion 12.

The control portion 12 includes a vehicle position detection unit 12a, a communication control unit 12b, a risk degree prediction unit 12c, a vehicle track detection unit 12d, a correlation determination unit 12e, and a notification control unit 12f. Each of these units 12a to 12f is provided by a computer program executed by the control portion 12, and is achieved by software.

The vehicle position detection unit 12a detects a vehicle position indicative of the position of the vehicle communication terminal 3 using the calculation result received from the GNSS positioning portion 14. The communication control unit 12b causes the wireless communication portion to receive the notification signal transmitted from the mobile communication terminal 2. The risk degree prediction unit 12c predicts the risk degree of the accident using the terminal position and the determination result of the action state included in the notification signal received by the communication control unit 12b, and the vehicle position detected by the vehicle position detection unit 12a. The vehicle track detection unit 12d detects a vehicle track indicative of a track of the vehicle communication terminal 3 using the change over time of the calculation result received from the GNSS positioning portion 14.

The correlation determination unit 12e determines whether there is a correlation between the terminal track included in the notification signal received by the communication control unit 12b and the vehicle track detected by the vehicle track detection unit 12d. The notification control unit 12f transmits a notification command signal to a vehicle notification device 15, and performs a notification to the driver by changing the notification content corresponding to the risk degree of the accident. The vehicle notification device 15 may be provided by a display of a navigation system, a head-up display, a speaker of an audio system, or the like.

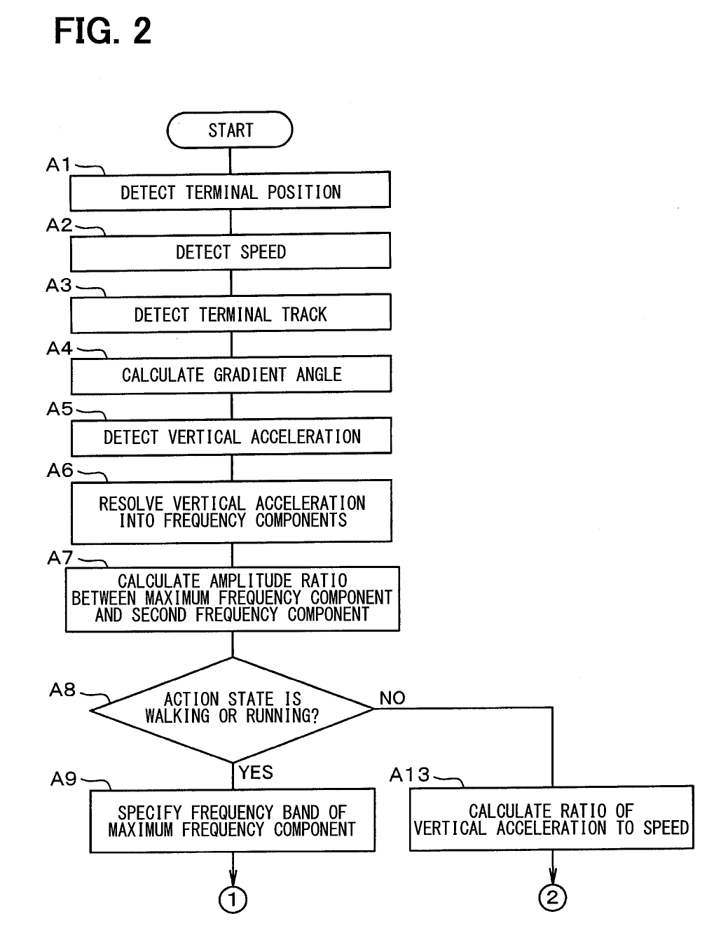

Next, the processing of the above configuration will be described with reference to FIG. 2 to FIG. 18. In the present embodiment, the control portion 4 of the mobile communication terminal 2 executes an action state determination processing and a reliability evaluation processing. The control portion 12 of the vehicle communication terminal 3 executes a risk level notification processing. Each processing will be sequentially explained below.

(1) Action State Determination Processing and Reliability Evaluation Processing

In the mobile communication terminal 2, when determining that a start condition of the action state determination processing is satisfied, the control portion 4 starts the action state determination processing. When the action state determination processing starts, the control portion 4 detects the terminal position indicative of the position of the mobile communication terminal 2 using the calculation result received from the GNSS positioning portion 6 (A1, corresponding to a terminal position detection procedure). The control portion 4 detects the speed of the mobile communication terminal 2 (A2, corresponding to a speed detection procedure), and the terminal track indicative of the track of the mobile communication terminal 2 (A3) using the change over time of the calculation result received from the GNSS positioning portion 6.

The control portion 4 calculates the gradient angle of the mobile communication terminal 2 using gyro indicated by the gyro signal received from the gyro sensor 10 and terrestrial magnetism indicated by the geomagnetic signal received from the geomagnetic sensor 11 (A4). The control portion 4 detects the vertical acceleration of the mobile communication terminal 2 by correcting acceleration indicated by the acceleration signal received from the acceleration sensor 9 using the calculated gradient angle (A5, corresponding to an acceleration detection procedure).

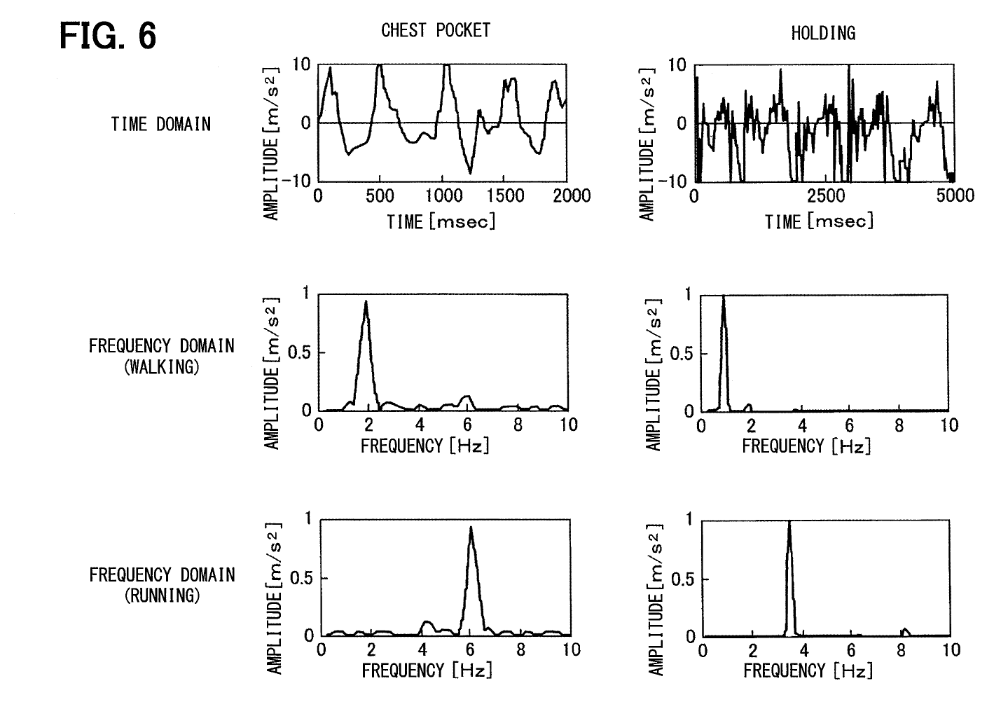

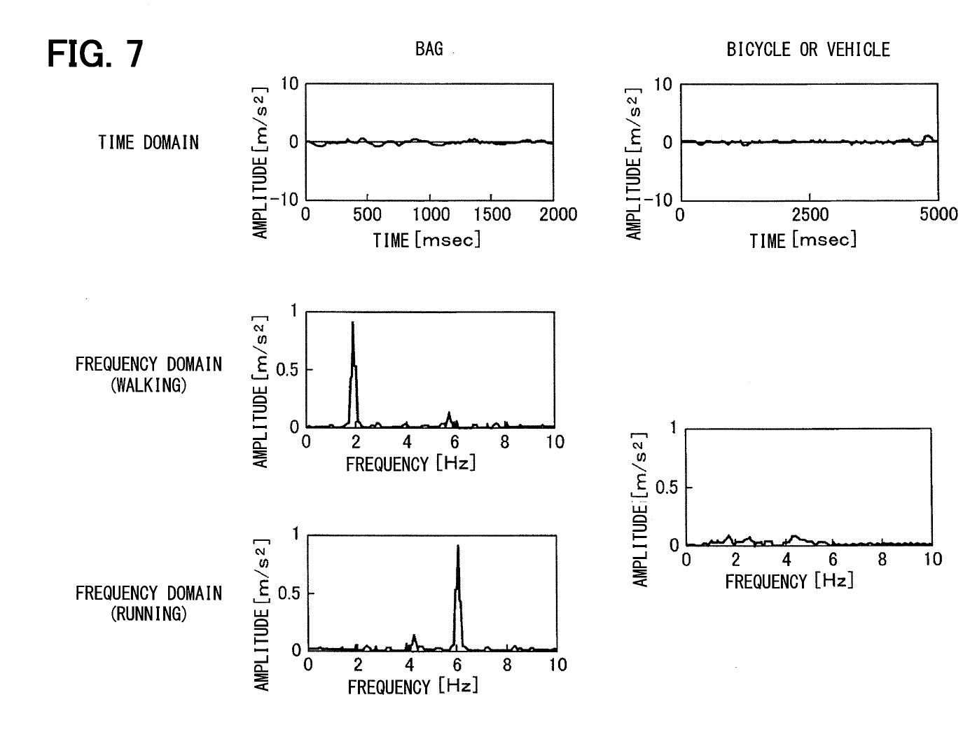

The control portion 4 resolves the vertical acceleration into the frequency components (A6), and calculates the amplitude ratio between the maximum frequency component and the second frequency component (A7). The control portion 4 compares the calculated amplitude ratio with a predetermined value (a value preliminary determined) in order to determine whether the action state is either walking or running or either riding the bicycle or riding on the vehicle (A8). That is, when the person possessing the mobile communication terminal 2 is walking or running, the left and right feet land alternately. Thus, even when the mobile communication terminal 2 is put in a chest pocket, held in hand, or put in a bag, a peak appears in the frequency domain as shown in FIG. 6 and FIG. 7. On the other hand, when the person possessing the mobile communication terminal 2 is riding the bicycle or riding on the vehicle, no peak appears in the frequency domain. When attention is paid to the time domain, it is impossible to determine whether the action state is either walking or running or either riding the bicycle or riding on the vehicle. On the other hand, when attention is paid to the frequency domain, it is possible to determine whether the action state is either walking or running or either riding the bicycle or riding on the vehicle by determining the presence or absence of the peak.

When the amplitude ratio between the maximum frequency component and the second frequency component is greater than the predetermined value and it is determined that the peak appears, the control portion 4 determines that the action state is walking or running (A8:YES), and specifies the frequency band of the maximum frequency component in order to specify the position of the peak (A9). The control portion 4 compares the specified maximum frequency component with a predetermined value (a value preliminary determined) in order to determine whether the action state is walking or running (A10). When the person is walking, the cycle in which the left and right feet land alternately becomes relatively long and the peak appears in the low frequency. When the person is running, the cycle in which the left and right feet land alternately becomes relatively short and the peak appears in the high frequency. When determining that the peak appears in the low frequency (A10:YES), the control portion 4 determines that the action state is walking (All, corresponding to an action state determination procedure). When determining that the peak appears in the high frequency (A10:NO), the control portion 4 determines that the action state is running (A12, corresponding to the action state determination procedure).

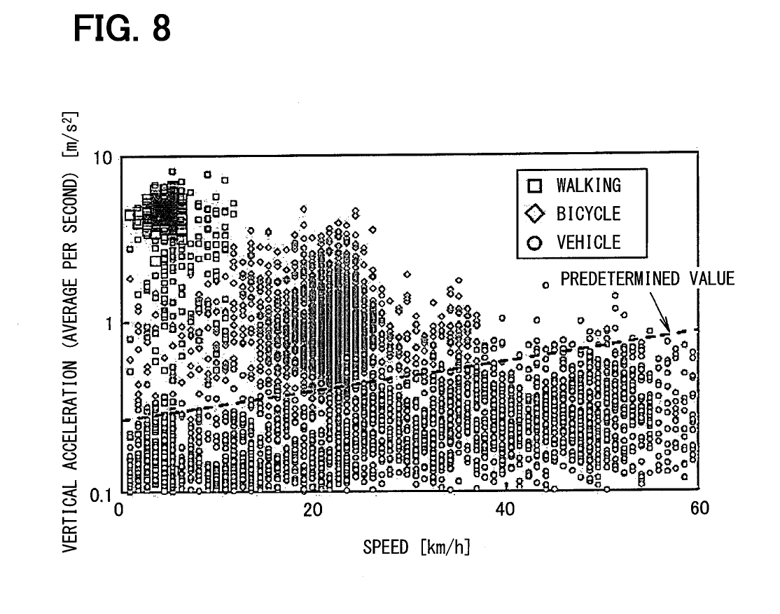

When the amplitude ratio between the maximum frequency component and the second frequency component is smaller than the predetermined value and it is determined that no peak appears, the control portion 4 determines that the action state is riding the bicycle or riding on the vehicle (A8:NO) and calculates a ratio of vertical acceleration to speed (A13). The control portion 4 compares the calculated ratio with a predetermined value (a value preliminary determined) in order to determine whether the action state is riding the bicycle or riding on the vehicle (A14). That is, as shown in FIG. 8, the ratio in case where the action state is riding the bicycle becomes relatively high, and the ratio in case where the action state is riding on the vehicle becomes relatively low. When determining that the ratio is relatively high and is higher than the predetermined value (A14:YES), the control portion 4 determines that the action state is riding the bicycle (A15, corresponding to the action state determination procedure). When determining that the ratio is relatively low and is lower than the predetermined value (A14:NO), the control portion 4 determines that the action state is riding on the vehicle (A16, corresponding to the action state determination procedure).

After determining that the action state is walking, running, riding the bicycle or riding on the vehicle, the control portion 4 determines whether the mobile communication terminal 2 is traveling (A17). When determining that the speed of the mobile communication terminal 2 is not “0” and the mobile communication terminal 2 is traveling (A17:YES), the control portion 4 shifts to the reliability evaluation processing (A18).

When the reliability evaluation processing starts, the control portion 4 determines whether the present determination result of the action state matches the present action state (A31). When determining that the present determination result of the action state matches the present action state (A31:YES), the control portion 4 determines whether the reliability index value reaches a predetermined maximum value (A32). When determining that the reliability index value does not reach the maximum value (A32:NO), the control portion 4 increases the reliability index value (A33), and determines whether the reliability index value is equal to more than a threshold value (a value preliminary determined) (A34). When determining that the reliability index value reaches the maximum value (A32:YES), the control portion 4 does not increase the reliability index value, and determines whether the reliability index value is equal to more than the threshold value (A34).

When determining that the present determination result of the action state does not match the present action state (A31:NO), the control portion 4 determines whether the present determination result of the action state matches a preceding determination result of the action state (A35). When determining that the present determination result of the action state does not match the preceding determination result of the action state (A35:NO), the control portion 4 decreases the reliability index value (A36), and determines whether the reliability index value is equal to more than the threshold value (A34). When determining that the present determination result of the action state matches the preceding determination result of the action state (A35:YES), the control portion 4 increases the decrease amount of the reliability index value (A37), decreases the reliability index value (A36), and determines whether the reliability index value is equal to more than the threshold value(A34).

When determining that the reliability index value is equal to or greater than the threshold value (A34:YES), the control portion 4 maintains the present action state (A38), terminates the reliability evaluation processing, and returns to the action state determination processing. When determining that the reliability index value is less than the threshold value (A 34:NO), the control portion 4 changes the present action state by newly setting the present determination result of the action state to the present action state (A39), sets the reliability index value to the initial value (A40), terminates the reliability evaluation processing, and returns to the action state determination processing.

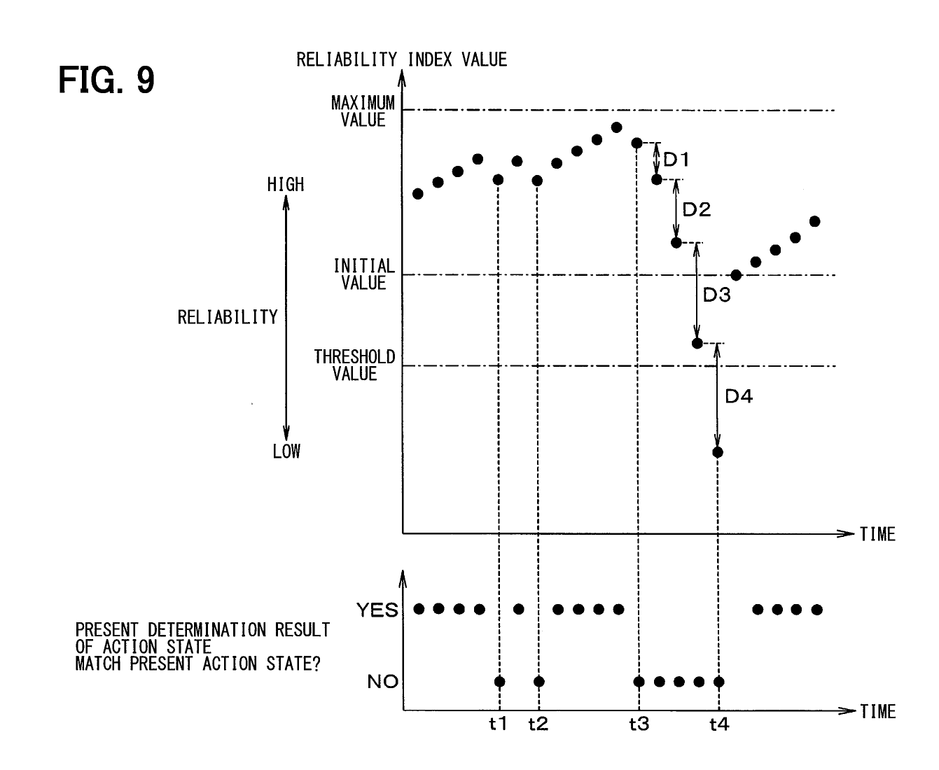

As shown in FIG. 9, the control portion 4 determines whether the present determination result of the action state matches the present action state, and determines whether the present determination result of the action state matches the preceding determination result of the action state. In this configuration, the control portion 4 increases or decreases the reliability index value. In the example of FIG. 9, the control portion 4 determines that the present determination result of the action state does not match the present action state at the time points t1 and t2. At following time point of each of the time points t1 and t2, the control portion 4 determines that the present determination result of the action state matches the present action state. The control portion 4 determines that the present determination result of the action state does not match the present action state at the time point t3. Even after the following time point of the time point t3 (that is, successively), the control portion 4 determines that the present determination result of the action state does not match the present action state. When the present determination result of the action state does not match the present action state but matches the preceding determination result of the action state in succession, the control portion 4 increases the decrease amount of the reliability index value (That is, D1<D2<D3<D4). The control portion 4 determines that the reliability index value becomes less than the threshold value at the time point t4. At following time point of the time point t4, the control portion 4 changes the present action state by newly setting the present determination result of the action state to the present action state, and sets the reliability index value to the initial value.

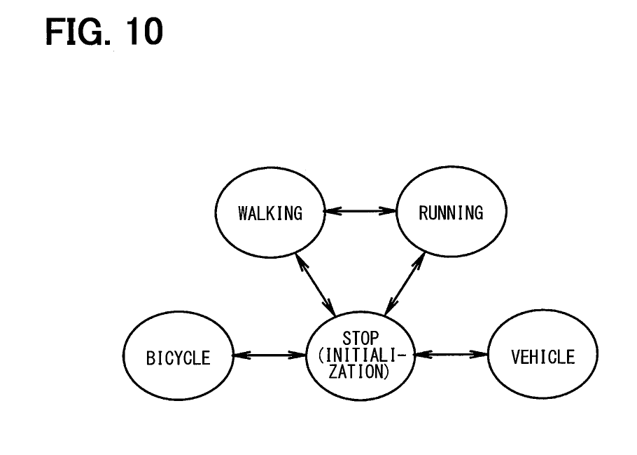

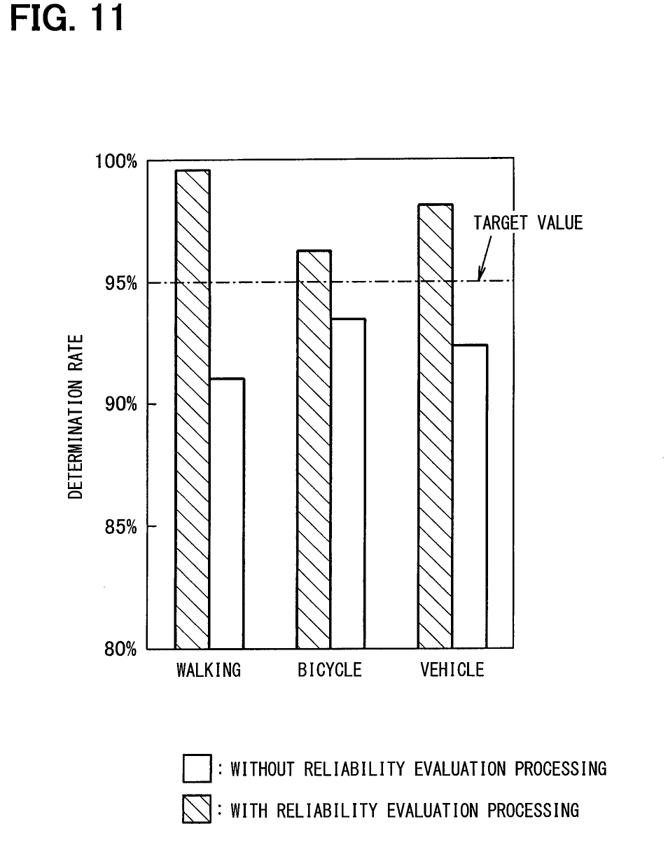

When returning to the action state determination processing, the control portion 4 causes the wireless communication portion 5 to transmit the notification signal to the vehicle communication terminal 3 (A19) and terminates the action state determination processing. The notification signal includes the terminal position indicative of the position of the mobile communication terminal 2, the terminal track indicative of the track of the mobile communication terminal 2, the determination result of the action state (that is, the present action state). On the other hand, when the speed of the mobile communication terminal 2 is “0” and the control portion 4 determines that the mobile communication terminal 2 is not traveling (A17:NO), the control portion 4 initializes the present action state (A20), sets the reliability index value to the initial value (A21), and terminates the action state determination processing. As shown in FIG. 10, when the action state changes between walking and running, the speed of the mobile communication terminal 2 does not become “0”. Thus, the control portion 4 does not initialize the present action state. On the other hand, when the action state changes between walking and riding the bicycle or riding on the vehicle, between running and riding the bicycle or riding on the vehicle, or between riding the bicycle and riding on the vehicle, the speed of the mobile communication terminal 2 temporarily becomes “0”. Thus, the control portion 4 initializes the present action state, and sets the reliability index value to the initial value. FIG. 11 shows a result of simulating how much determination ratio of the action state is improved by the reliability evaluation processing. By executing the reliability evaluation processing, the determination ratio of the action state increases, and erroneous determination of the action state can be reduced.

(2) Risk Level Notification Processing

In the vehicle communication terminal 3, when determining that a start condition of the risk level notification processing is satisfied, the control portion 12 starts the risk level notification processing. When the risk level notification processing starts, the control portion 12 detects the vehicle position indicative of the position of the vehicle communication terminal 3 using the calculation result received from the GNSS positioning portion 14 (B1, corresponding to a vehicle position detection procedure). The control portion 12 detects the vehicle track indicative of the track of the vehicle communication terminal 3 using the change over time of the calculation result received from the GNSS positioning portion 14 (B2). The control portion 12 determines whether the notification signal transmitted from the mobile communication terminal 2 is received through the wireless communication portion 13 (B3). When determining that the notification signal transmitted from the mobile communication terminal 2 is received through the wireless communication portion 13 (B3:YES), the control portion 12 specifies the terminal position indicative of the position of the mobile communication terminal 2, the terminal track indicative of the track of the mobile communication terminal 2, and the determination result of the action state (B4).

The control portion 12 determines whether there is a correlation between the terminal track and the vehicle track (B5). The control portion 12 calculates the location history of the mobile communication terminal 2 from the terminal track, and calculates the location history of the vehicle communication terminal 3 from the vehicle track. The control portion 12 determines whether there is the correlation between the terminal track and the vehicle track by comparing the location history of the communication terminal 2 with the location history of the vehicle communication terminal 3. In this case, when the mobile communication terminal 2 is in the subject vehicle to which the vehicle communication terminal 3 is attached, the location history of the mobile communication terminal 2 matches the location history of the vehicle communication terminal 3. On the other hand, when the mobile communication terminal 2 is not in the subject vehicle to which the vehicle communication terminal 3 is attached, the location history of the mobile communication terminal 2 does not match the location history of the vehicle communication terminal 3. That is, the control portion 12 determines that the mobile communication terminal 2 is in the subject vehicle to which the vehicle communication terminal 3 is attached by determining whether there is the correlation between the terminal track and the vehicle track, so that the mobile communication terminal 2 (for example, the mobile communication terminal 2 carried in the subject vehicle by the driver) is excluded from a prediction target of the risk degree of the accident, which will be described later.

When the location history of the mobile communication terminal 2 does not match with the location history of the vehicle communication terminal 3 and the control portion 12 determines that there is no correlation between the terminal track and the vehicle track (B5: NO), the control portion 12 predicts the risk degree of the accident using the terminal position, the determination result of the action state, and the vehicle position (B6, corresponding to a risk degree prediction procedure). The control portion 12 determines whether it is necessary to perform the notification based on predicted risk degree of the accident (B7).

The control portion 12 sets a predicted progress area of the mobile communication terminal 2 corresponding to the action state. The travel distance of the mobile communication terminal 2 per unit time increases in an ascending order of walking, running, riding the bicycle, and riding on the vehicle. That is, the control portion 12 sets the predicted progress area of the mobile communication terminal 2, and the predicted progress area becomes wider corresponding to the above-described order. When the margin of time until the predicted progress area of the mobile communication terminal 2 overlaps a predicted progress area of the vehicle communication terminal 3 is relatively short and the control portion 12 determines that it is necessary to perform the notification (B7:YES), the control portion 12 transmits the notification command signal to the vehicle notification device 15. In this configuration, the control portion 12 notifies the driver by changing the notification content corresponding to the risk degree of the accident (B8, a notification control procedure), and terminates the risk level notification processing. The predicted progress area of the mobile communication terminal 2 may not overlap the predicted progress area of the vehicle communication terminal 3, or the margin of time until the predicted progress area of the mobile communication terminal 2 overlaps the predicted progress area of the vehicle communication terminal 3 may be relatively long. In this case, the control portion 12 determines that it is not necessary to perform the notification (B7:NO). Thus, the control portion 12 does not notify the driver of the notification content, and terminates the risk level notification processing.

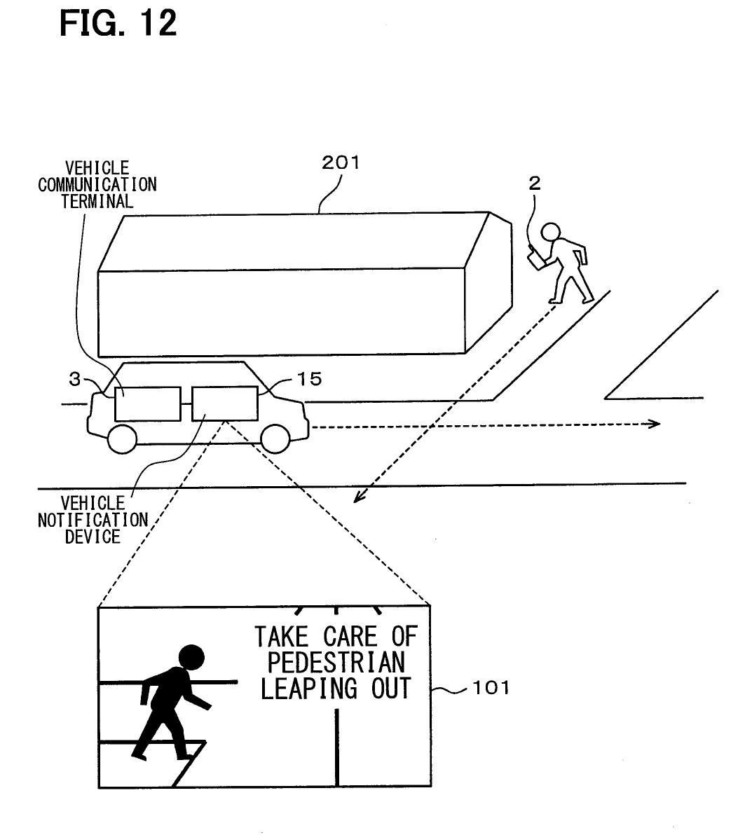

As shown in FIG. 12, when determining that the action state is walking and it is necessary to perform the notification, the control portion 12 causes the vehicle notification device 15 to display a warning screen 101. The warning screen 101 shows a warning message of “take care of the pedestrian leaping out”. With this configuration, the control portion 12 calls attention to leaping out of the pedestrian. Even when the pedestrian possessing the mobile communication terminal 2 hides behind a building 201 and is invisible to the driver, the driver can pay attention to leaping out of the pedestrian by visually recognizing the warning screen 101. Similarly, when determining that the action state is running and it is necessary to perform the notification, the control portion 12 causes the vehicle notification device 15 to display a warning screen. The warning screen shows a warning message of “take care of the pedestrian rushing out”. With this configuration, the control portion 12 calls attention to rushing out of the pedestrian.

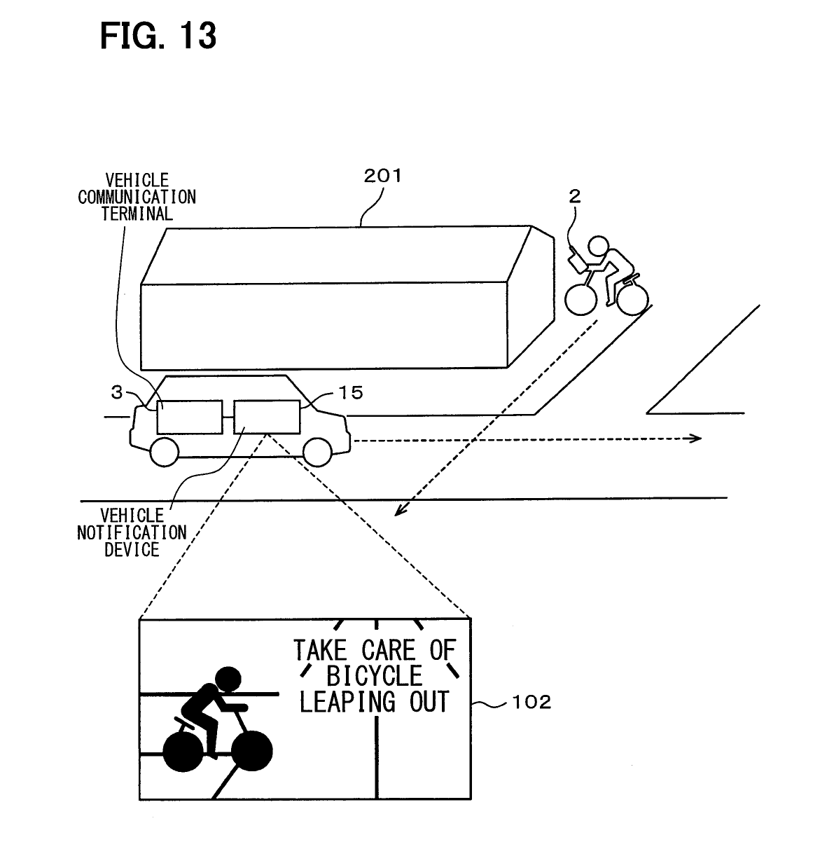

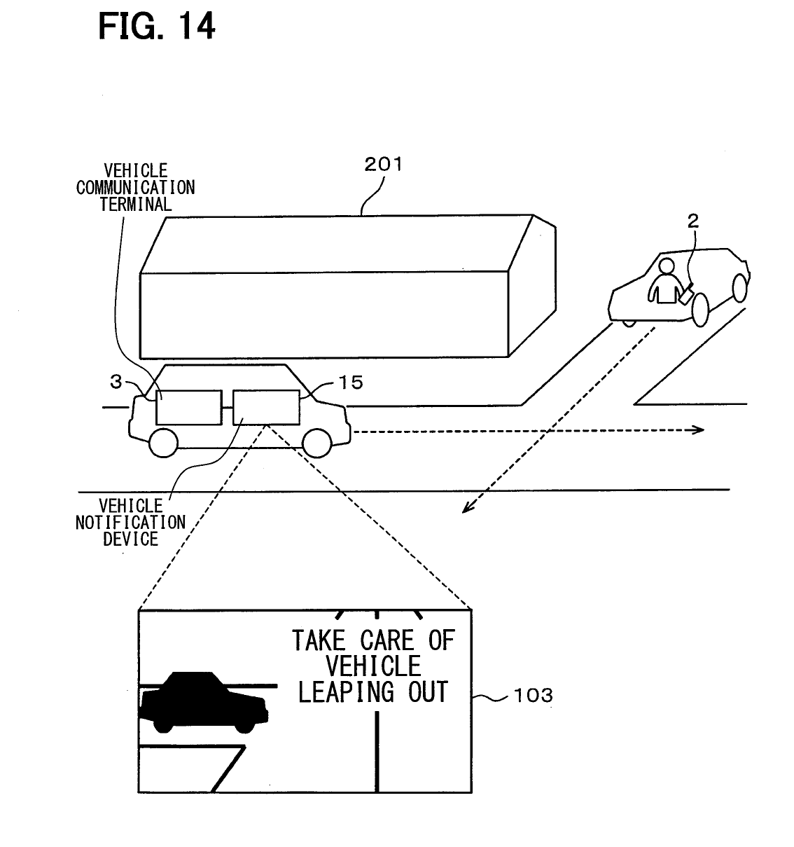

As shown in FIG. 13, when determining that the action state is riding the bicycle and it is necessary to perform the notification, the control portion 12 causes the vehicle notification device 15 to display a warning screen 102. The warning screen 102 shows a warning message of “take care of the bicycle leaping out”. With this configuration, the control portion 12 calls attention to leaping out of the bicycle. As shown in FIG. 14, when determining that the action state is riding on the vehicle and it is necessary to perform the notification, the control portion 12 causes the vehicle notification device 15 to display a warning screen 103. The warning screen 103 shows a warning message of “take care of the vehicle leaping out”. With this configuration, the control portion 12 calls attention to leaping out of the vehicle.

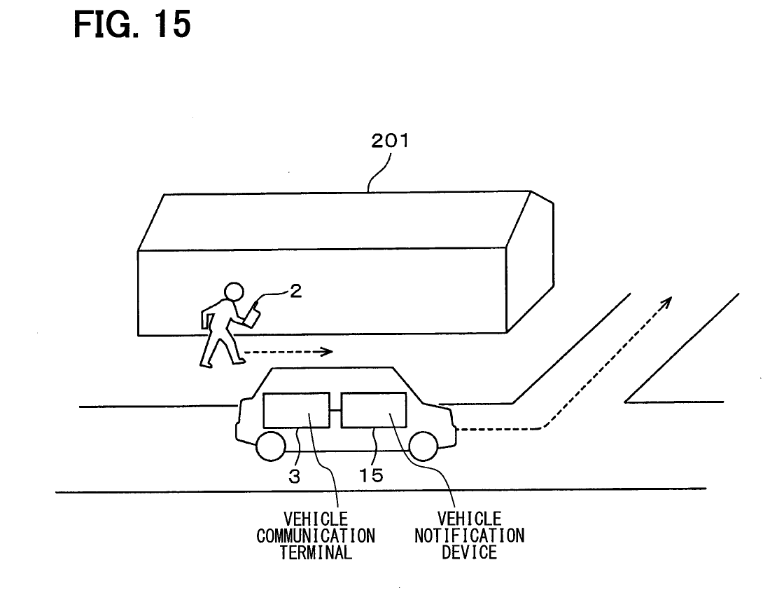

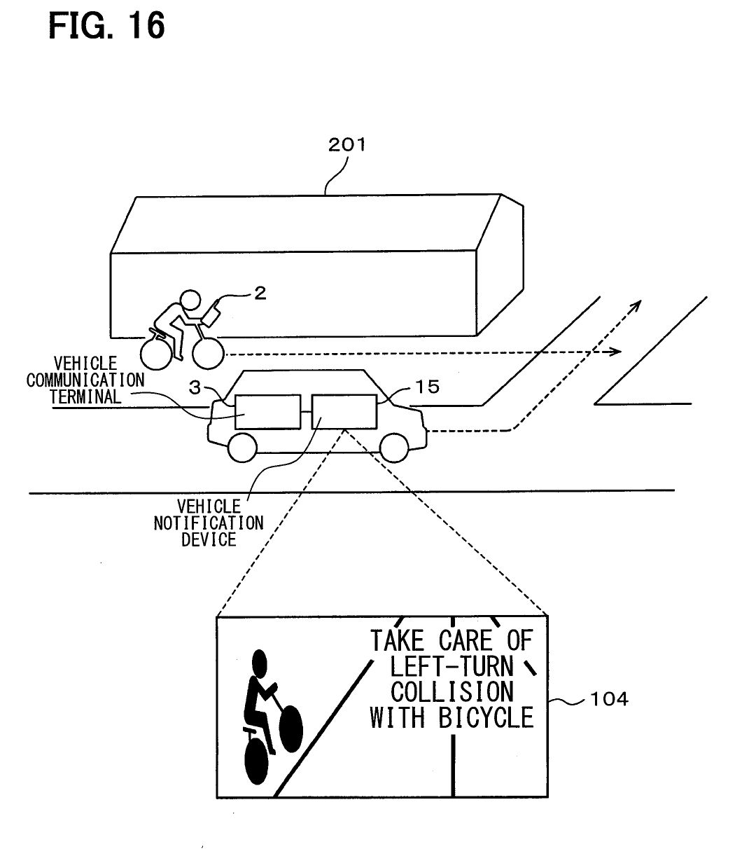

When the control portion 12 determines that the action state is walking, the speed of the mobile communication terminal 2 is relatively slow and the margin of time is relatively long. Thus, as shown in FIG. 15, when the subject vehicle having the vehicle communication terminal 3 turns left, the control portion 12 determines that it is not necessary to perform the notification and does not cause the vehicle notification device 15 to display the warning screen. When the control portion 12 determines that the action state is riding the bicycle, the speed of the mobile communication terminal 2 is relatively high and the margin of time is relatively short. Thus, as shown in FIG. 16, when the subject vehicle having the vehicle communication terminal 3 turns left, the control portion 12 determines that it is necessary to perform the notification and cause the vehicle notification device 15 to display a warning screen 104. The warning screen 104 displays a warning message of “take care of left-turn collision with the bicycle”. With this configuration, the control portion 12 calls attention to left-turn collision with the bicycle. Even when the driver fails to check the rear left of the subject vehicle, the warning screen 104 is displayed so that attention can be paid to the left-turn collision with the bicycle.

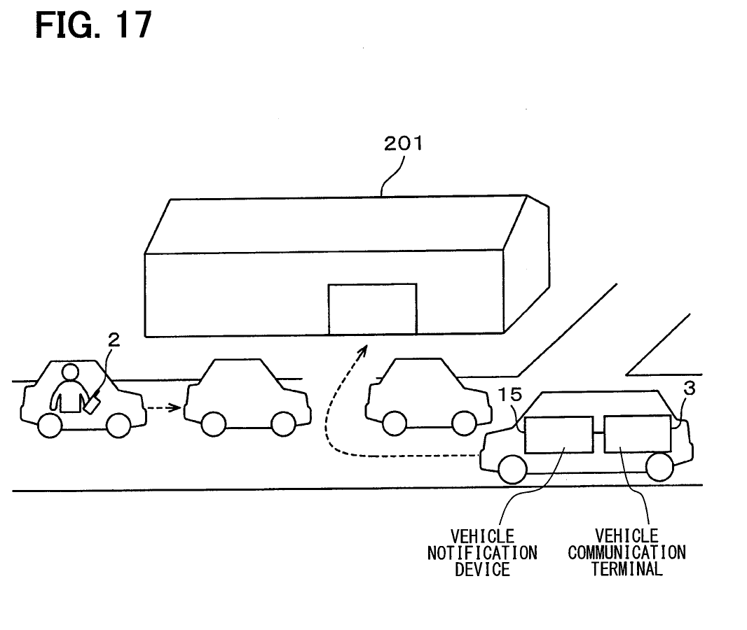

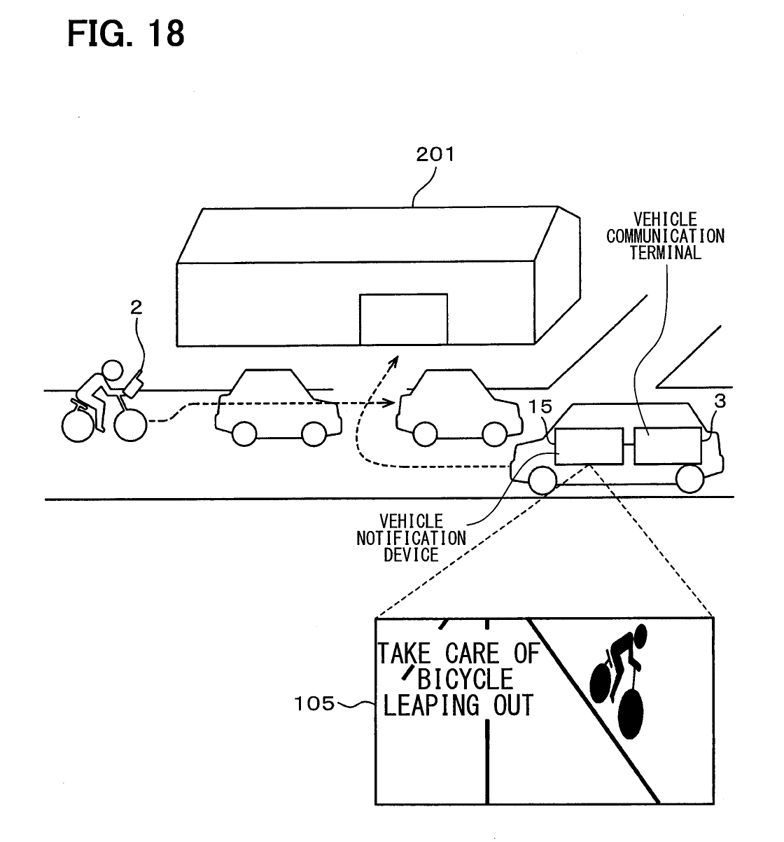

The subject vehicle having the vehicle communication terminal 3 may turn right and cross between oncoming vehicles. As shown in FIG. 17, when the control portion 12 determines that the action state is riding on the vehicle, the preceding vehicle interrupts the travel of the following vehicle so that the control portion 12 determines that it is not necessary to perform the notification and does not cause the vehicle notification device 15 to display the warning screen. As shown in FIG. 18, when the control portion 12 determines that the action state is riding the bicycle, the oncoming vehicle does not interrupt the travel of the bicycle so that the control portion 12 determines that it is necessary to perform the notification and causes the vehicle notification device 15 to display the warning screen 105. The warning screen 105 shows a warning message of “take care of the bicycle leaping out”. With this configuration, the control portion 12 calls attention to leaping out of the bicycle. Even when the bicycle hides behind the oncoming vehicle and is invisible to the driver, the driver can pay attention to leaping out of the bicycle by visually recognizing the warning screen 105.

The above configuration describes an example of a one-to-one relationship between the mobile communication terminal 2 and the vehicle communication terminal 3. Alternatively, the relationship between the mobile communication terminal 2 and the vehicle communication terminal 3 may be a many-to-one relationship. In this case, when a number of pedestrians exist, the control portion 12 predicts the risk degree of the accident to each of the pedestrians. The control portion 12 may cause the vehicle notification device 15 to display a warning screen for urging caution to each of the pedestrians. In addition, when a pedestrian and a bicycle exist, the control portion 12 predicts the risk degree of the accident to each of the pedestrian and the bicycle. The control portion 12 may cause the vehicle notification device 15 to display a warning screen for urging caution to each of the pedestrian and the bicycle. When displaying the warning screen with multiple objects, the control portion 12 may notify the level of the risk degree of the accident. An object with the highest risk degree of the accident may be displayed in red, and an object with the second highest risk degree of the accident may be displayed in yellow. Suppose that a warning screen for urging caution to each of the pedestrian and the bicycle is displayed. In this case, when the risk degree of the bicycle is relatively high and the risk degree of the pedestrian is relatively low, the control portion 12 displays the bicycle in red and displays the pedestrian in yellow.

The configuration described in the first embodiment can provide advantages below.

The vehicle notification system 1 determines the action state of the person possessing the mobile communication terminal 2 by being classified into walking, running, riding the bicycle or riding on the vehicle. With this configuration, the vehicle notification system 1 can appropriately determine the action state of the person possessing the mobile communication terminal 2 so as to avoid the accident involving the person possessing the mobile communication terminal 2 with the vehicle in advance.

The vehicle notification system 1 resolves vertical acceleration of the mobile communication terminal 2 into the frequency components, and calculates the amplitude ratio between the maximum frequency component and the second frequency component. The vehicle notification system 1 compares the calculated amplitude ratio with the predetermined value in order to determine whether the action state is either walking or running or either riding the bicycle or riding on the vehicle. By comparing the amplitude ratio between the maximum frequency component and the second frequency component with the predetermined value, the vehicle notification system 1 can distinguish whether the action state is either walking or running or either riding the bicycle or riding on the vehicle.

The vehicle notification system 1 specifies the frequency band of the maximum frequency component of the vertical acceleration of the mobile communication terminal 2. The vehicle notification system 1 compares the specified frequency band with the predetermined value so as to determine whether the action state is walking or running. By comparing the frequency band of the maximum frequency component with the predetermined value, the vehicle notification system 1 can distinguish whether the action state is walking or running.

The vehicle notification system 1 calculates the ratio of the vertical acceleration to the speed of the mobile communication terminal 2. The vehicle notification system 1 compares the calculated ratio with the predetermined value so as to determine whether the action state is riding the bicycle or riding on the vehicle. By comparing the ratio of vertical acceleration to speed with the predetermined value, the vehicle notification system 1 can distinguish whether the action state is riding the bicycle or riding on the vehicle.

Further, the vehicle notification system 1 calculates the reliability index value. When determining that the present determination result of the action state matches the present action state, the vehicle notification system 1 increases the reliability index value. When determining that the present determination result of the action state does not match the present action state, the vehicle notification system 1 decreases the reliability index value. When the reliability index value becomes less than the threshold value, the vehicle notification system 1 changes the present action state. By using the reliability index value, the vehicle notification system 1 can improve the accuracy of determining the action state of the person possessing the mobile communication terminal 2.

When determining that the present determination result of the action state does not match the present action state but present determination result of the action state matches the preceding determination result of the action state, the vehicle notification system 1 increases the decrease amount of the reliability index value. With this configuration, when determining that the present determination result of the action state does not match the present action state in succession, the vehicle notification system 1 can promptly change the present action state.

In addition, the vehicle notification system 1 performs the notification when there is no correlation between the terminal track and the vehicle track. On the other hand, the vehicle notification system 1 does not perform the notification when there is the correlation between the terminal track and the vehicle track. The vehicle notification system 1 sets the mobile communication terminal 2, which exists outside the subject vehicle having the vehicle communication terminal 3, as the prediction target of the risk degree of the accident. On the other hand, the vehicle notification system 1 excludes the mobile communication terminal 2, which exists inside the subject vehicle having the vehicle communication terminal 3, from the prediction target of the risk degree of the accident. With this configuration, the vehicle notification system 1 can avoid performing unnecessary notification. In addition, the configuration can suppress the power consumption of the mobile communication terminal 2, which exists inside the subject vehicle having the vehicle communication terminal 3.

### Second Embodiment

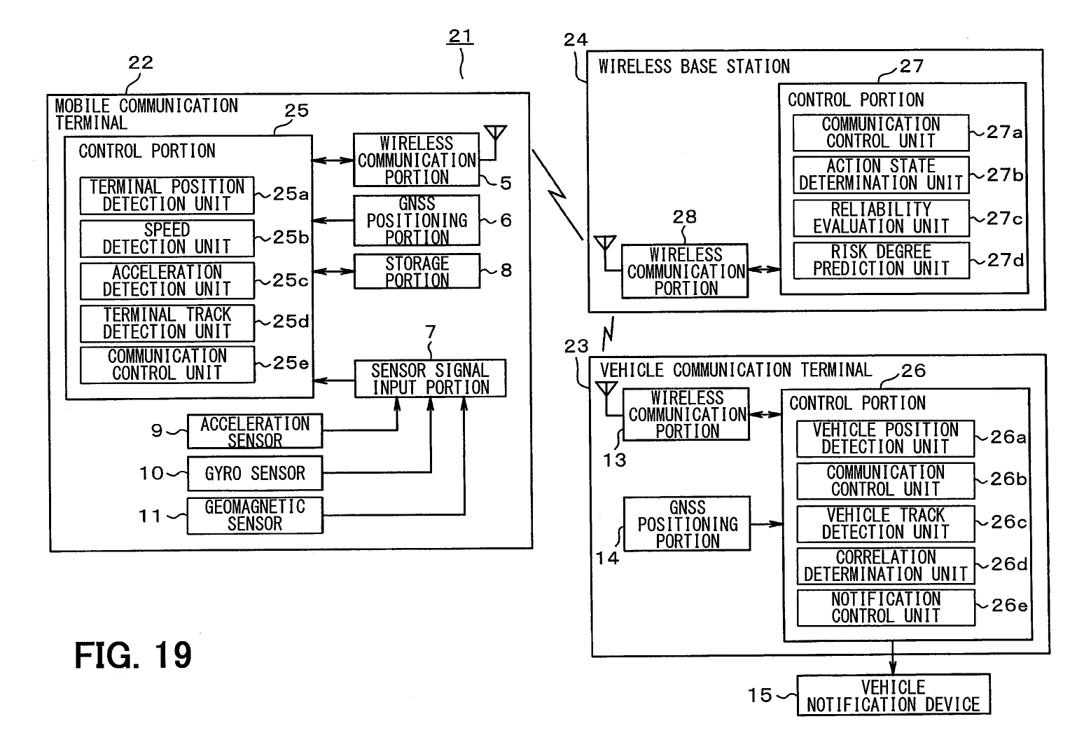

Next, a second embodiment will be described with reference to FIG. 19. Hereinafter, the description of the same parts as those in the first embodiment will be omitted, and only different parts will be described. In the first embodiment, the mobile communication terminal 2 and the vehicle communication terminal 3 directly communicate with one another. In the second embodiment, a mobile communication terminal and a vehicle communication terminal communicate with one another via a wireless base station.

In a vehicle notification system 21, a mobile communication terminal 22 and a vehicle communication terminal 23 are capable of communicating with one another via a wireless base station 24. The mobile communication terminal 22 includes a control portion 25, the wireless communication portion 5, the GNSS positioning portion 6, the sensor signal input portion 7, and the storage portion 8. The control position 25 includes a terminal position detection unit 25a, a speed detection unit 25b, an acceleration detection unit 25c, a terminal track detection unit 25d and a communication control unit 25e. The vehicle communication terminal 23 includes a control portion 26, the wireless communication portion 13, and the GNSS positioning portion 14. The control portion 26 includes a vehicle position detection unit 26a, a communication control unit 26b, a vehicle track detection unit 26c, a correlation determination unit 26d, and a notification control unit 26e. The wireless base station 24 includes a control portion 27 and a wireless communication portion 28. The control portion 27 includes a communication control unit 27a, an action state determination unit 27b, a reliability evaluation unit 27c, and a risk degree prediction unit 27d. Each of the action state determination unit 27b, the reliability evaluation unit 27c, and the risk degree prediction unit 27d has the similar function to each of the action state determination unit 4d, the reliability evaluation unit 4e, and the risk degree prediction unit 12c, respectively.

With the above-described configuration in the second embodiment, the same operational effects as in the first embodiment can be obtained. Since the action state determination unit 27b, the reliability evaluation unit 27c, and the risk degree prediction unit 27d are provided in the wireless base station 24, the processing load of each of the mobile communication terminal 22 and the vehicle communication terminal 23 can be reduced. Alternatively, a function similar to the function of the correlation determination unit 26d may be provided in the wireless base station 24. Alternatively, each functional block may be distributed in other manners.

### Other Embodiments

Although the present disclosure has been described in accordance with the embodiments, it is understood that the present disclosure is not limited to the embodiments and structures. The present disclosure may cover various modification examples and equivalent arrangements. Furthermore, various combinations and formations, and other combinations and formations including one, more than one or less than one element may be included in the scope and the spirit of the present disclosure.

Each of the mobile communication terminal 2 and the vehicle communication terminal 3 may dedicate itself to a terminal for performing the above-described processing.

In the present disclosure, the configuration calculates the present position using the GNSS signal received from the satellites. Alternatively, the present position may be calculated using communication radio waves of a wireless base station such as WiFi (Wireless Fidelity) (registered trademark).

1. A vehicle notification system including a mobile communication terminal and a vehicle communication terminal, the mobile communication terminal configured to be possessed by a person, the vehicle communication terminal attached to a subject vehicle, and the mobile communication terminal and the vehicle communication terminal performing a wireless communication with one another,
the vehicle notification system comprising a processor configured to:
detect a terminal position indicative of a position of the mobile communication terminal;
detect speed of the mobile communication terminal;
detect vertical acceleration of the mobile communication terminal;
determine whether an action state of the person possessing the mobile communication terminal is walking, running, riding a bicycle, or riding on a vehicle using the speed and the vertical acceleration;
detect a vehicle position indicative of a position of the vehicle communication terminal;
predict a risk degree of accident using the terminal position, a determination result of the action state, and the vehicle position; and
perform a notification by changing a notification content corresponding to the risk degree of accident,
wherein
the processor is further configured to:
resolve the vertical acceleration into frequency components, calculate an amplitude ratio between a maximum frequency component and a second frequency component, compare the calculated amplitude ratio with a predetermined value, and determine whether the action state is either walking or running or either riding the bicycle or riding on the vehicle;
specify a frequency band of the maximum frequency component, compare the specified frequency band with a predetermined value, and determine whether the action state is walking or running; and
calculate a ratio of the vertical acceleration to the speed, compare the calculated ratio with a predetermined value, and determine whether the action state is riding the bicycle or riding on the vehicle.

2. The vehicle notification system according to claim 1, wherein:
the processor is further configured to:
calculate a reliability index value indicative of a reliability of the determination result of the action state;
increase the reliability index value when a present determination result of the action state matches a present action state;
decrease the reliability index value when the present determination result of the action state mismatches the present action state; and
change the present action state when the reliability index value becomes less than a predetermined value.

3. The vehicle notification system according to claim 2, wherein
the processor is further configured to increase a decrease amount of the reliability index value when the present determination result of the action state mismatches the present action state and the present determination result of the action state matches a preceding determination result of the action state.

4. The vehicle notification system according to claim 1, wherein
the processor is further configured to:
detect a terminal track indicative of a track of the mobile communication terminal;
detect a vehicle track indicative of a track of the vehicle communication terminal;
determine whether there is a correlation between the terminal track and the vehicle track; and
perform the notification when there is no correlation.

5. The vehicle notification system according to claim 1, wherein:
the mobile communication terminal and the vehicle communication terminal directly perform the wireless communication with one another;
the mobile communication terminal includes a first processor configured to:
detect the terminal position indicative of the position of the mobile communication terminal;
detect the speed of the mobile communication terminal;
detect the vertical acceleration of the mobile communication terminal; and
determine whether the action state of the person possessing the mobile communication terminal is walking, running, riding the bicycle, or riding on the vehicle using the speed and the vertical acceleration; and
the vehicle communication terminal includes a second processor configured to:
detect the vehicle position indicative of the position of the vehicle communication terminal;
predict the risk degree of accident using the terminal position, the determination result of the action state, and the vehicle position; and
perform the notification by changing the notification content corresponding to the risk degree of accident.

6. The vehicle notification system according to claim 1, wherein:
the mobile communication terminal and the vehicle communication terminal perform the wireless communication with one another via a wireless base station;
the mobile communication terminal includes a first processor configured to:
detect the terminal position indicative of the position of the mobile communication terminal;
detect the speed of the mobile communication terminal; and
detect the vertical acceleration of the mobile communication terminal;
the vehicle communication terminal includes a second processor configured to:
detect the vehicle position indicative of the position of the vehicle communication terminal; and
perform the notification by changing the notification content corresponding to the risk degree of accident; and
the wireless base station includes a third processor configured to:
determine whether the action state of the person possessing the mobile communication terminal is walking, running, riding the bicycle, or riding on the vehicle using the speed and the vertical acceleration;
predict the risk degree of accident using the terminal position, the determination result of the action state, and the vehicle position; and

7. A computer program product stored in a non-transitory tangible computer readable storage medium, the computer program product comprising instructions executed by a processor of a vehicle notification system, the vehicle notification system including a mobile communication terminal and a vehicle communication terminal, the mobile communication terminal configured to be possessed by a person, the vehicle communication terminal attached to a subject vehicle, and the mobile communication terminal and the vehicle communication terminal performing a wireless communication with one another,
the instructions comprising:
detecting a terminal position indicative of a position of the mobile communication terminal;
detecting speed of the mobile communication terminal;
detecting vertical acceleration of the mobile communication terminal;
(i) resolving the vertical acceleration into frequency components, calculating an amplitude ratio between a maximum frequency component and a second frequency component, comparing the calculated amplitude ratio with a predetermined value, and determining whether the action state is either walking or running or either riding a bicycle or riding on a vehicle, (ii) specifying a frequency band of the maximum frequency component, comparing the specified frequency band with a predetermined value, and determining whether the action state is walking or running, and (iii) calculating a ratio of the vertical acceleration to the speed, comparing the calculated ratio with a predetermined value, and determining whether the action state is riding the bicycle or riding on the vehicle;
detecting a vehicle position indicative of a position of the vehicle communication terminal;
predicting a risk degree of accident using the terminal position, a determination result of the action state, and the vehicle position; and
performing a notification by changing a notification content corresponding to the risk degree of accident.

8. A computer-readable non-transitory storage medium storing the computer program product according to claim 7.

9. A vehicle notification system including a mobile communication terminal and a vehicle communication terminal, the mobile communication terminal configured to be possessed by a person, the vehicle communication terminal attached to a subject vehicle, and the mobile communication terminal and the vehicle communication terminal performing a wireless communication with one another,
the vehicle notification system comprising:
a terminal position detection unit configured to detect a terminal position indicative of a position of the mobile communication terminal;
a speed detection unit configured to detect speed of the mobile communication terminal;
an acceleration detection unit configured to detect vertical acceleration of the mobile communication terminal;
an action state determination unit configured to determine whether an action state of the person possessing the mobile communication terminal is walking, running, riding a bicycle, or riding on a vehicle using the speed and the vertical acceleration;
a vehicle position detection unit configured to detect a vehicle position indicative of a position of the vehicle communication terminal;
a risk degree prediction unit configured to predict a risk degree of accident using the terminal position, a determination result of the action state, and the vehicle position; and
a notification control unit configured to perform a notification by changing a notification content corresponding to the risk degree of accident,
wherein:
the action state determination unit resolves the vertical acceleration into frequency components, calculates an amplitude ratio between a maximum frequency component and a second frequency component, compares the calculated amplitude ratio with a predetermined value, and determines whether the action state is either walking or running or either riding the bicycle or riding on the vehicle;
the action state determination unit specifies a frequency band of the maximum frequency component, compares the specified frequency band with a predetermined value, and determines whether the action state is walking or running; and
the action state determination unit calculates a ratio of the vertical acceleration to the speed, compares the calculated ratio with a predetermined value, and determines whether the action state is riding the bicycle or riding on the vehicle.
